(19) United States
(12) Patent Application Publication
(10) Pub. No.: US 2021/0287240 A1
(43) Pub. Date: Sep. 16, 2021

(54) NETWORK MARKETING COMPENSATION SYSTEM CONTAINING NON-NETWORKING COMPONENT

(71) Applicant: Nature's Sunshine Products, Inc., Lehi, UT (US)

(72) Inventors: Derek Christensen, Payson, UT (US); Shawn Henry, Highland, UT (US)

(21) Appl. No.: 17/199,719

(22) Filed: Mar. 12, 2021

Related U.S. Application Data
(60) Provisional application No. 62/989,366, filed on Mar. 13, 2020.

(51) Int. Cl. G06Q 30/02; G06Q 50/00; G06Q 20/02

(52) U.S. Cl. CPC G06Q 30/0214; G06Q 50/01; G06Q 20/023; G06Q 30/0239; G06Q 30/0215; G06Q 30/0277

(57) ABSTRACT

Network marketing compensation systems and methods that have been modified to include compensation for those that are not initially in the network are described. In particular, this application describes compensation methods that include creating a network compensation system for sales of products, the system containing a unilevel distribution network with at least five levels of distributors, allowing an affiliate to recommend a product to a customer, allocating a position in the network to the affiliate, and distributing compensation under the system to the affiliate and the distributor in near real time upon purchase of the product by the customer. These compensation systems and associated methods have a great potential to increase involvement by customers (and others outside the network like an affiliate) that otherwise might not be attracted to it. Other embodiments are described.

### CROSS-REFERENCE TO RELATED APPLICATION

This patent application claims priority of U.S. Provisional Application Ser. No. 62/989,366, filed on Mar. 13, 2020, the entire disclosure of which is hereby incorporated by reference.

### FIELD

This application relates generally to compensation systems used in network marketing companies. More specifically, this application describes network marketing compensation systems and methods that have been modified to include compensation for those that are not initially in the network.

### BACKGROUND

There are many compensation plans that are known and used in network marketing companies, also known as multi-level marketing (MLM) companies. These are used to compensate distributors who sell the products in the MLM companies. The compensation plans are built on the premise that a distributor is paid not only for what he or she can sell, but also what his or network can sell. Known compensation plans include matrix plans and binary plans. In binary plans, a primary distributor is allowed a limited number (i.e., 2) of frontline distributors, but the primary distributor will receive commissions for the entire downline of each frontline distributor depending on the qualified status and the downline depth is not limited. Thus, binary plans are characterized as providing commissions for distribution trees having finite width, but theoretically an infinite depth. On the other hand, matrix compensation plans typically have a finite width and a finite depth. In other words, matrix compensation plans have a limited number of distributors who can be placed on each distributor's downline, with a limited depth for each downline that the distributor will earn commissions from.

### SUMMARY

This application relates generally to network marketing compensation systems and associated methods that have been modified to include compensation for those that are not initially in the network. In particular, this application describes compensation methods that include creating a network compensation system for sales of products, the system containing a unilevel distribution network with at least five levels of distributors, allowing an affiliate to recommend a product to a customer, allocating a position in the network to the affiliate, and distributing compensation under the system to the affiliate and the distributor in near real time upon purchase of the product by the customer. These compensation systems and associated methods have a great potential to increase involvement by customers (and others outside the network like an affiliate) that otherwise might not be attracted to it.

### BRIEF DESCRIPTION OF THE DRAWINGS

The following description can be better understood in light of the Figures which show various embodiments and configurations of the compensation plans and associated methods.

FIG. 1 shows a view of some embodiments of a unilevel network marketing compensation system.

FIG. 2 shows other embodiments of a unilevel network marketing compensation system.

FIG. 3 shows yet other embodiments of a unilevel network marketing compensation system.

FIG. 4 shows some embodiments a unilevel network marketing compensation system containing a non-networking component.

FIG. 5 shows some embodiments of a computer system that can be used with the system architecture depicted in FIG. 6.

FIG. 6 shows some embodiments of a system architecture that can be used with the compensation system depicted in FIG. 4.

Together with the following description, the Figures demonstrate and explain the principles of the structures, methods, and principles described herein. In the drawings, the thickness and size of components may be exaggerated or otherwise modified for clarity. The same reference numerals in different drawings represent the same element, and thus their descriptions will not be repeated. Furthermore, well-known structures, materials, or operations are not shown or described in detail to avoid obscuring aspects of the described devices.

### DETAILED DESCRIPTION

The following description supplies specific details in order to provide a thorough understanding. Nevertheless, the skilled artisan will understand that the described compensation systems and associated methods can be implemented and used without employing these specific details. Indeed, the described compensation systems and associated methods can be placed into practice by modifying the described systems and methods and can be used in conjunction with any other apparatus and techniques conventionally used in the industry. For example, while the description below focuses on unilevel network marketing compensation plans, it could also be used with other network compensation plans including binary, matrix, breakaway, and any other MLM compensation plans.

In addition, as the terms on, disposed on, attached to, connected to, or coupled to, etc. are used herein, one object (e.g., a material, element, structure, member, etc.) can be on, disposed on, attached to, connected to, or coupled to another object—regardless of whether the one object is directly on, attached, connected, or coupled to the other object or whether there are one or more intervening objects between the one object and the other object. Also, directions (e.g., on top of, below, above, top, bottom, side, up, down, under, over, upper, lower, lateral, orbital, horizontal, etc.), if provided, are relative and provided solely by way of example and for ease of illustration and discussion and not by way of limitation. Where reference is made to a list of elements (e.g., elements a, b, c), such reference is intended to include any one of the listed elements by itself, any combination of less than all of the listed elements, and/or a combination of all of the listed elements. Furthermore, as used herein, the terms a, an, and one may each be interchangeable with the terms at least one and one or more.

The figures show some embodiments of the network marketing compensation systems and associated methods that contain a non-networking component. In network marketing, distributors (who are independent contractors) earn their income through a compensation system (or compensation plan) based on their abilities and results to sell products and recruit others within their network to sell and/or recruit others as well. Network marketing is often called multi-level marketing (MLM). There are generally three parts to the compensation system: retail profits, commissions, and bonuses. The retail profit is the amount earned when the distributor, who has purchased the product at wholesale from her/his company, sells the product at retail. A commission is the amount(s) paid on sales of others in your network, often called the downline. A bonus refers to other, optional sources of income, including one-time performance achievement rewards, monthly allowances (i.e., for a car), etc. which can be based on a rank status that is qualified for based on overall network performance.

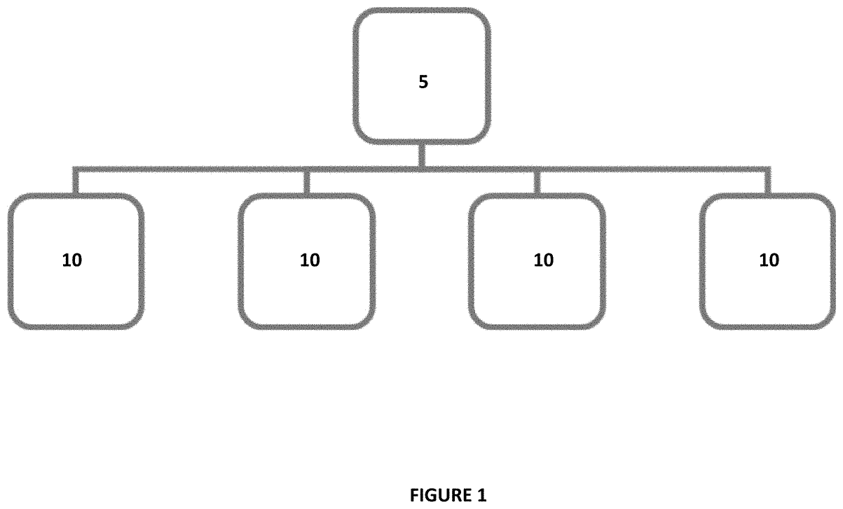

Known compensation systems for multi-level marketing (MLM) companies include unilevel plans, matrix plans and binary plans, among others. In unilevel plans, as shown in FIG. 1, a primary distributor 5 has a single frontline of sponsored distributors 10 that are directly beneath the primary distributor in their distribution tree. There can be an unlimited number of frontline distributors in this type of plan. The primary distributor 5 will earn commissions off of each frontline distributor 10 and that distributors' downline, i.e. distributors beneath a frontline distributor, but limited to a predetermined depth. Accordingly, unilevel plans are characterized as providing commissions for distribution trees of essentially infinite width, but only finite depth. For example, in a unilevel plan, everyone a distributor enrolls is on their first level and there is no limit to how many people a distributor can recruit onto her first level. As long as the distributor keeps personally enrolling, that first level will keep growing.

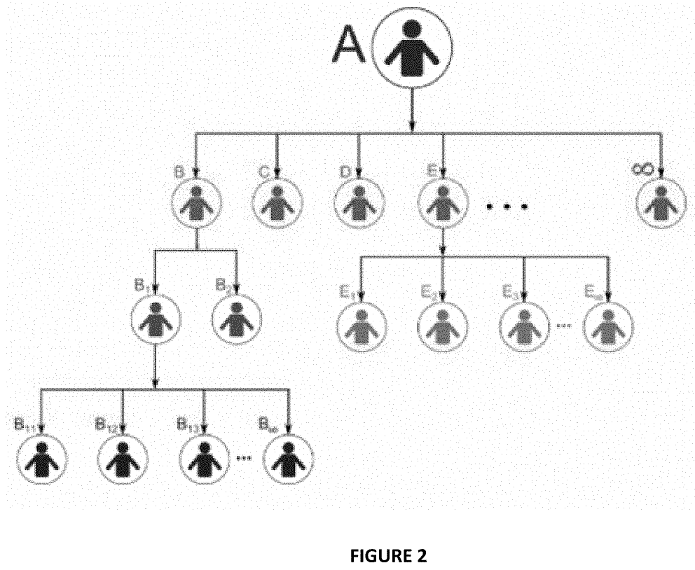

The name unilevel does not mean that there is one level of distributors. Indeed, it can have as many levels as desired. Typically, the number of levels can be limited by the amount of money payed out under the system. An example of a three-level system (or tree) is illustrated in FIG. 2 with A being the primary distributor, the first level comprising distributors B, C, D, E, . . . , the second level comprising B1, B2, E1, E2, E3, E4, . . . , and the third and bottom level comprising B11, B12, B13, etc.

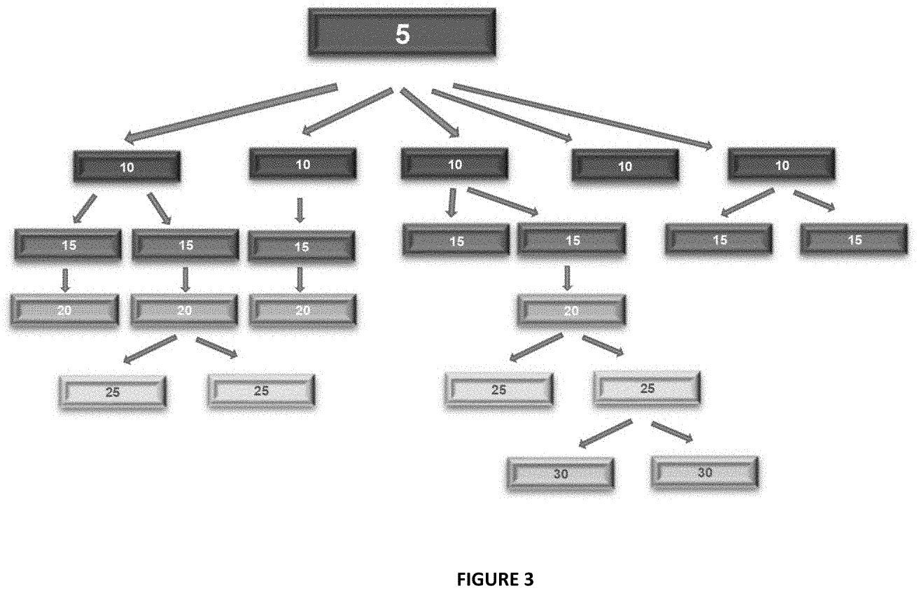

Often in unilevel compensation systems, a larger percentage is paid on the first level with decreasing amounts paid on lower levels. For example, on the 1st level (represented by boxes 10) shown in the system/tree of FIG. 3, the primary distributor 5 may get 12% of the sales volume of what the direct downline. While on the second level (represented by boxes 15), one may only receive 10%, with 10% on the third level (represented by boxes 20), 2% on the 4th level (represented by boxes 25), and 1% on the fifth level (represented by boxes 30). An important component of a unilevel plan is the level of commission: distributors earn a percentage on personal volume generated in a specific number of levels of their downlines. In most unilevel compensation systems, as an individual moves to a higher rank within the system, he or she can qualify to earn commissions on more levels, as well as earn other bonuses.

Typically, the unilevel commission pays distributors a percentage on the personal volume of their distributors (and the recruits of their distributors). Most of the distributors in this tree are people the primary distributor 5 didn't personally recruit. Toward the bottom of the tree, the primary distributor 5 may have put no direct effort at all to generate the volume or to recruit the distributors 25 and 30.

A drawback to most network marketing compensation plans is inherent in their name They are first limited to those within a person's network. And second, they are limited to those within that network who can be convinced to join as a distributor in the system. And third, a distributor is typically only rewarded if someone inside of their network purchases a product(s)—they get little compensation if someone outside their network makes a purchase.

The network marketing compensation systems described herein accordingly contain a non-networking component. Under these systems, a customer who is not part of any network compensation system can purchase products from the company operating the network marketing compensation system. The consumer purchasing the product(s) can become an affiliate of the compensation system by recommending the purchased products to others (i.e., connections in her network) who are not part of the system. As an affiliate, that person can be rewarded by those connections who purchase the recommended products. But the affiliate does not need to become an official distributor to be rewarded.

The affiliate can be any type of entity. In some embodiments, the affiliate is merely a consumer who merely purchased the products of the company. In other embodiments, the affiliate could be the owner of multiple websites or email marketing lists. In yet other embodiments, the affiliate could be another corporate organization, such as a limited liability company, or any other type of group.

The affiliate can promote the products via any number of mechanisms. One mechanism allows the affiliate to promote the products on any corporate sponsored websites, for example, right after they have purchased the product(s). Another mechanism that can be used by the affiliate is implementing banner ads, text ads, or links on its own websites or via email to its own connections. Yet another mechanism that can be used by the affiliate is to share information about the products, including a purchase link with a discount code, via social media, or any other type of e-commerce mechanism.

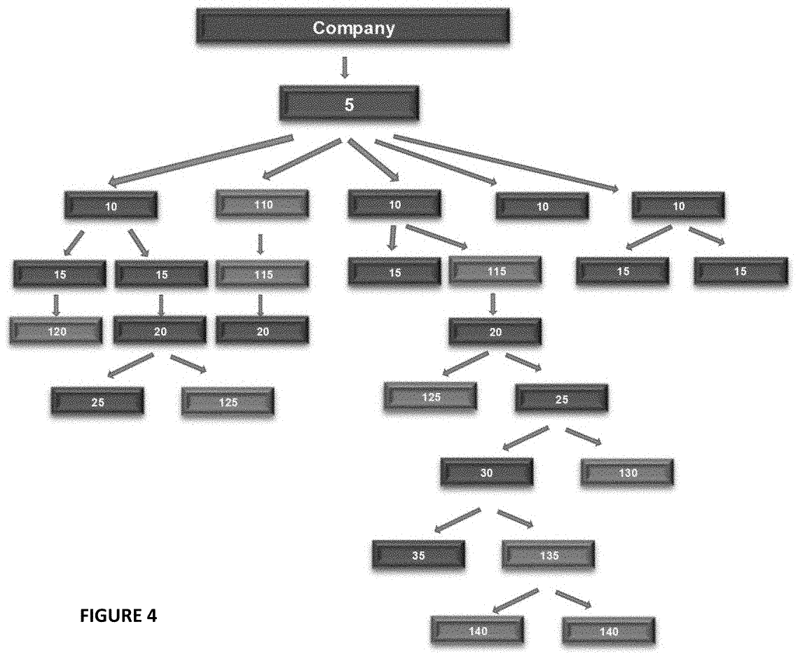

In some instances, the customer purchasing the product can have been referred by a distributor in the network. In these instances, the customer is assigned a designated location in the compensation plan. For example, as shown in FIG. 4, if a customer purchased a product because of a recommendation by distributor 20, the customer occupies position 125 that is placed in a level under that distributor 20. Likewise, if the customer purchased a product because of a recommendation by distributor 25, the customer occupies position 130 that is placed in a level under that distributor 25.

In other instances, though, the customer purchasing the product has not been referred by a distributor in the network, but rather by another customer. In these instances, the compensation system can automatically assign the customer to the specific location with the compensation system beneath the referring customer. For example, as shown in FIG. 4, as a customer purchases the company's product(s) without a recommendation by a distributor, but referred by customer 135, the customer could be assigned to position 140 in a level under customer 135.

In some instances, a customer could find the products without a referral from someone else. These organically-generated new customers can be linked directly to the company. While they are eligible to participate in the compensation system by creating their own downline, with all rights and privileges of any other customer, their purchases do not generate commissions for any uplines in the network compensation system. This configuration provides the company with the opportunity to invest in their own efforts to start new, autonomous downlines.

In other instances, a customer could find the products via a link shared by another customer or affiliate. Thus, these customers will be allocated a downline position in the compensation system and eventually will have a first upline distributor allocated above them (with the exceptions described herein). For example, if distributor A has referred customer 1, who refers customer 2, who refers customer 3, who refers affiliate 1, who refers customer 4, who refers affiliate 2, who refers customer 5, then when customer 5 purchases a product, affiliate 2 can receive the compensation (i.e., 15%), and distributor A will become the first upline individual to receive distributor pay in the compensation system. In this example, distributor A's upline will—based on eligibility—be the second individual to receive distributor compensation under the compensation system.

In yet other instances, the customer can become an affiliate of an affiliate. In these instances, the compensation system can automatically assign the customer who buys on the recommendation of a given affiliate to an affiliate position with the compensation system. For example, as shown in FIG. 4, a customer who purchases the company's product(s) with a recommendation from affiliate 110 could be assigned as an affiliate 115 in a level under the affiliate 110.

In some configurations of the compensation system, the affiliate can continue to operate as an affiliate provided he or she continues recommending products that are purchased by others and/or through personal purchases. If the affiliate stops recommending products or making personal purchases for a given period of time, such as 30, 60, or 90 days, the compensation system can remove the affiliate status and that person becomes merely a customer. Of course, should the former-affiliate (and now-customer) begin to recommend products that are purchased by others, that person could then qualify again as an affiliate.

Even though an affiliate is rewarded with a place in the compensation system which appears similar to a distributor, for example in block 110 on the same level as next to distributor 10 as shown in FIG. 4, the affiliate is typically compensated differently than a distributor. Like a distributor, the affiliate is rewarded with a specific percentage (i.e., 15%) of the products sales. So if an affiliate shared a discount link with a customer who purchased $100 in products, the affiliate will be compensated with $15. This compensation applies regardless of the volume purchased by the customer(s) of the affiliate. Unlike a distributor, though, the affiliate is not compensated via any other mechanism in the compensation plan. In some configurations, the compensation received by the affiliate is only a specific percentage of the product price rather than a calculation of a normalized purchase volume (PV) assigned to individual products.

When the sale occurs from a recommended product of an affiliate, the distributors upline of the affiliate are also compensated. At the time the affiliate enters the compensation plan, there is no one downline of the affiliate. So there is no downline compensation at that point in time. If additional affiliates or distributors become part of the compensation plan after the affiliate enters, then downline compensation can occur for future sales.

The distributors upline of the affiliate can also be compensated in the following manner. The first distributor upline of the affiliate, for example distributor 20 for affiliate 125, that distributor can be compensated with up to a specific percentage of the sales depending on the rank of the distributor, i.e., depending and how high or low that distributor is located in the compensation plan. In one example, the first upline distributor could make up to about 20% (i.e., about 5, about 10, or about 15, or about 20%) of the products sales depending on the location in the compensation plan. The second distributor upline of the affiliate, for example distributor 15 for affiliate 125, that distributor can be compensated with up to a specific percentage of the sales depending on the rank of the distributor, i.e., depending and how high or low that distributor is located in the compensation plan. In one example, the second upline distributor could make up to about 10% (i.e., about 2.5, about 5, or about 7.5%) of the products sales depending on the location and qualification eligibility of the second upline distributor in the compensation plan. Optionally, additional upline distributors could also be compensated in a similar manner.

In the compensation system, distributors also can benefit by advancing in a rank within the system. When customers purchase products from an affiliate, the payment occurs for only 3 levels as described above, i.e., the affiliation and the two upline distributors. But every sale in a downline—no matter how far removed—can contribute to the rank qualification of every upline distributor. And a higher rank within the compensation plan can offer additional benefits in the compensation plan.

In some embodiments, the customer is not aware that they have become an affiliate under the compensation system. In these embodiments, the customer merely continues to be compensated as described herein, i.e., by receiving the designated percentage of the sales of the products to others that they have recommended the product to.

In other embodiments, though, the customer is aware of the fact that they have become an affiliate in the compensation system. As an affiliate, he or she can be rewarded by those in her network (i.e., 1^{st} connections) who purchase the products she recommends. When those 1^{st} connections, in turn, share product recommendations with their network (i.e., 2^{nd} connections), the affiliate is given the opportunity to upgrade their status to distributor to receive benefits when the 2^{nd} connections purchase products, but to a lesser degree than when 1^{st} connections purchase products. As additional connections in the expanding network (i.e., 3^{rd}, 4^{th}, 5^{th}, etc. connections) purchase products, the benefits diminish and are eliminated altogether depending on factors such as qualification requirements related to overall in-network sales and breadth of network. This affiliate compensation differs from a unilevel compensation system where a distributor can continue to benefit from the ever-expanding people in the network.

In some configurations, an affiliate in the compensation system can be a customer (i.e., non-distributor) individual who may be actively or inactively sharing either products or referrals with other individuals that are not regular customers. In these configurations, the affiliate is a customer who accepts an affiliate agreement under the system. She may then be compensated for the purchases made by any her direct referrals in the form or cash or product credit which could be credited to her account. Therefore, all referral relationships (i.e., the structure and functionality of the tree illustrated in FIG. 4) are unchanged whether the individual holds either a regular customer status or affiliate status. And, a referral relationship in either direction (i.e., up or down in the tree in FIG. 4) can be formed with any combination of customer/affiliate/distributor.

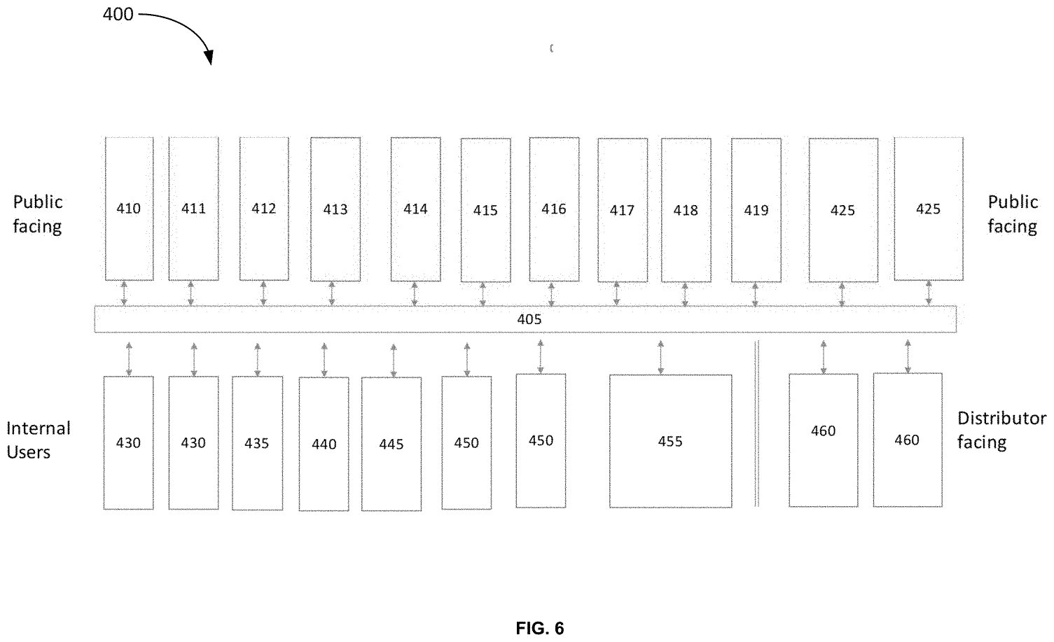

In some configurations, the compensation system can contain the system architecture 400 as shown in FIG. 6. The components in FIG. 6 are examples only and do not limit the use or functionality of any hardware, hardware combined with software, firmware, embedded logic component, or a combination of two or more such components. The system architecture 400 connects all of the components shown in FIG. 6 using a universal interface 405 that incorporates micro services. The system architecture 400 contains a configurable web platform containing a series (410 through 419) of web platforms for different countries and/or divisions within the company. The system architecture 400 also contains third party web platforms 425 that can be integrated into the system. All of these web platforms are public facing to the customers and/or the affiliates.

The system architecture 400 also contains platforms 460 that can be used by distributors to manage their operations with the company. The system architecture 400 can also contain an enterprise data warehouse 455 for managing all of the data within the system. Order fulfillment of products can be managed by an ERP system 450 in the system architecture 400. The operations and finances can be managed by an electronic business platform 445, such as an Oracle EBS (e-business suite).

The system architecture 400 contains a platform for near real time payment of compensation under the plan. This near real time payment can be calculated in mere seconds (or minutes) and distributed to the affiliate and/or distributor within minutes (or hours). Other existing MLM compensation plans typically only compensate their distributors only on a monthly basis.

This real time payment platform contains a commission module 430, a payments module 435, and an audit module 440. The commission module 430 tracks the payments due to the affiliate(s) and to the distributor(s) by calculating them within mere seconds (or minutes) of the product(s) purchase. In some configurations, the commissions module comprises a commission engine with a 5 level unilevel module as well as a 3 level customer sharing module developed with an Angular front-end (based on Google technology) and a Microsoft MS-SQL database. The payment module 435 distributes the payments to the affiliate(s) and to the distributor(s) within in mere minutes (or hours) once the information is received from the payments module. The payment module 435 can distribute the funds in any form desired by the company, affiliate and/or distributor, including cryptocurrency, gift cards, ACH transfer, wire, credit to an existing account, electronic transfer to a debit card or credit card, and/or generation and delivery of a paper check. In some configurations, the payment module 435 can comprise a third party payment platform, such as PayQuicker, Zelle, Venmo, or Paypal. The audit module 440 in the real time payment platform is used to audit commissions and payment and make sure that payments are compliant with the commission plan. The real time payment platform uses in-memory processing for commission calculation and quicker payments. In-memory processing is a technology that processes data stored in one or more in-memory databases. Unlike older systems based on disk storage and relational databases using SQL queries, in-memory processing accesses data stored in RAM or flash memory and allows the data to be analyzed (i.e., payments calculated and distributed) in near real time.

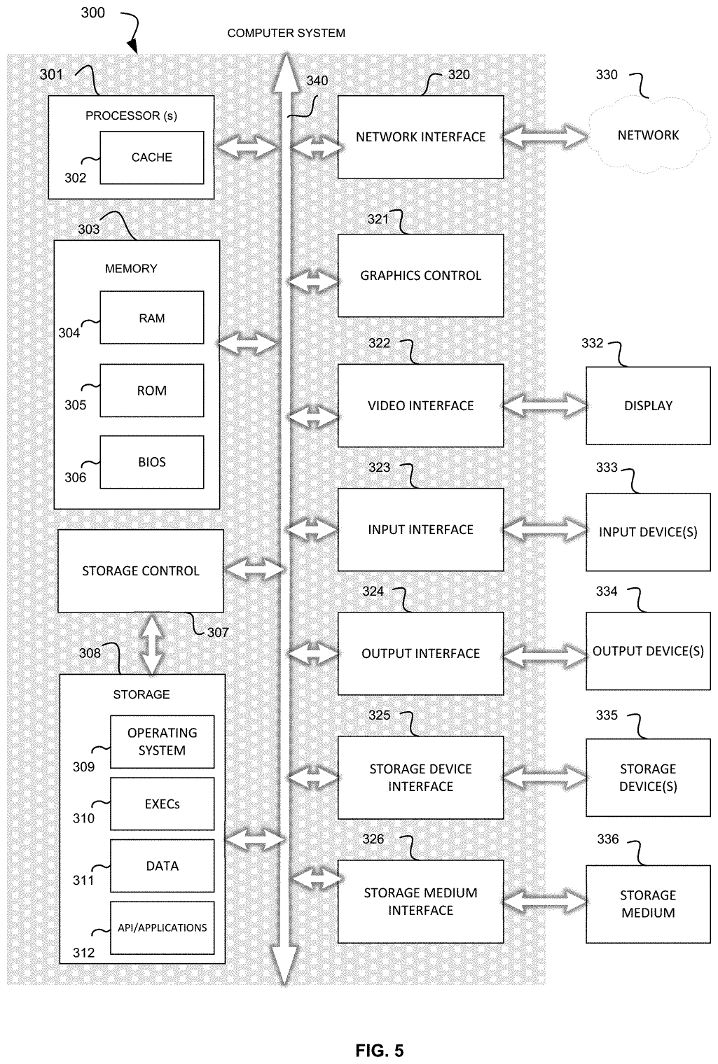

The system architecture 400, can be implemented in connection with any electronics that will perform the functions described, including using the computer system illustrated in FIG. 5. Computer system 300 contains a set of non-transitory, processor executable instructions to perform or execute any of the methods described herein. The components in FIG. 5 are examples only and do not limit the use or functionality of any hardware, hardware combined with software, firmware, embedded logic component, or a combination of two or more such components. The computer system 300 can be implemented as a general purpose server, virtual machine, in the cloud, on a computer (e.g., a laptop computer), mobile device (e.g., tablet or smart phone) or an embedded logic device (e.g., an FPGA), to name just some non-limiting examples. As well, computer system 300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 300 includes a processor 301 (or multiple processors) such as a central processing unit (CPU), graphical processing unit (GPU), application specific integrated circuit (ASIC), or a field programmable gate array (FPGA). The computer system 300 may also contain a memory component (or memory) 303 and a storage component (storage) 308 that communicate with each other and with other components via a bus 340. The bus 340 may also link one or more displays 332, one or more input devices 333 (e.g., a keypad, a keyboard, a mouse, a stylus, etc.), one or more output devices 334, one or more storage devices 335, and various non-transitory, tangible computer-readable storage media 336 with each other and with the processor 301, the memory 303, and the storage 308. All of these components can communicate directly or via one or more interfaces or adaptors to the bus 340. For example, the various non-transitory, tangible computer-readable storage media 336 can interface with the bus 340 via storage medium interface 326.

Processor(s) 301 optionally contains a cache memory unit 302 for temporary local storage of instructions or data. Processor(s) 301 can also execute computer-readable instructions stored on at least one non-transitory, tangible computer-readable storage medium. Computer system 300, as a result of the processor(s) 301, may also execute software embodied in one or more non-transitory, tangible computer-readable storage media, such as memory 303, storage 308, storage devices 335, or storage medium 336 (i.e., read only memory or ROM). The non-transitory, tangible computer-readable storage media may store software that implements particular embodiments, and processor(s) 301 may execute the software.

Memory 303 may implement and/or execute the software from one or more other non-transitory, tangible computer-readable storage media (such as mass storage device(s) 335, 336) or from one or more other sources through any interface, such as network interface 320. The software may cause processor(s) 301 to carry the process(es) or step(s) of any process described herein. Executing such processes or steps may include defining data structures stored in memory 303 and modifying the data structures as directed by the software. In some embodiments, an FPGA can store instructions for carrying out the functionality while in other embodiments, firmware includes instructions for carrying out any functionality described herein.

The memory 303 may include various components (e.g., non-transitory, tangible computer-readable storage media) including random access memory component (e.g., RAM 304 whether static or dynamic RAM), a read-only component (e.g., ROM 305), and any combinations thereof. ROM 305 may communicate data and instructions uni-directionally to processor(s) 301, and RAM 304 may act to communicate data and instructions bi-directionally with processor(s) 301. ROM 305 and RAM 304 may include any suitable non-transitory, tangible computer-readable storage media. In some instances, ROM 305 and RAM 304 may include non-transitory, tangible computer-readable storage media for carrying out the methods described herein. A basic input/output system 306 (BIOS), including basic routines to transfer information between elements within computer system 300, may be stored in the memory 303.

Fixed storage 308 can be connected to processor(s) 301, optionally through storage control unit 307. Fixed storage 308 provides data storage capacity and may also include any suitable non-transitory, tangible computer-readable media described herein. Storage 308 may be used to store operating system 309, executable commands (EXEC) 310, data 311, API applications 312 (application programs), and the like. For example, multiple instances of the storage 308 could be used for storage by the machine learning module described herein. In some configurations, storage 308 can be a secondary storage medium (i.e., a hard disk) that is slower than primary storage (i.e., memory 303). Storage 308 can also include an optical disk drive, a solid-state memory device (e.g., flash-based systems), or a combination thereof. Information in storage 308 may also be incorporated as virtual memory in memory 303.

In some configurations, storage device(s) 335 may be removably interfaced with computer system 300 (e.g., via an external port connector (not shown)) via a storage device interface 325. Thus, storage device(s) 335 and an associated machine-readable medium may provide nonvolatile and/or volatile storage of machine-readable instructions, data structures, program modules, and/or other data for the computer system 300. For example, software may reside completely or partially within a machine-readable medium on storage device(s) 335. In another example, software may reside, completely or partially, within processor(s) 301.

Bus 340 connects a wide variety of subsystems and/or components in the computer system 300. Bus 340 may encompass one or more digital signal lines serving a common function. Bus 340 may also comprise any type of bus structures including a memory bus, a memory controller, a peripheral bus, a local bus, and any combinations thereof, using any of a variety of bus architectures. Such architectures may include any modern, common standards-based bus technologies or older architectures including an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and/or any combinations thereof.

Computer system 300 may also include an input device(s) 333. A user of computer system 300 may enter commands and/or other data into computer system 300 via input device(s) 333. Examples of an input device(s) 333 include an alpha-numeric input device (keyboard), a tracking device (mouse), a touchpad, touchscreen, a joystick, a gamepad, an audio input device (microphone), an optical scanner, a video or still image capture device (e.g., a camera), and any combinations thereof. Input device(s) 333 may interface with bus 340 via any number of input interfaces 323 including serial, parallel, network, game port, USB, FIREWIRE, fiber optic, or any combination thereof.

When computer system 300 is connected to a network 330, the computer system 300 may communicate with other electronic devices, such as mobile devices and enterprise systems, that are connected to network 330. Communications to and from computer system 300 may be sent through a network interface 320 which may receive incoming communications in the form of one or more packets (such as Internet Protocol (IP) packets) from network 330. Computer system 300 may then store the incoming communications in memory 303 for processing. Computer system 300 may also store outgoing communications in the form of one or more packets in memory 303 and communicate them to network 330 via network interface 320. Examples of the network interface 320 include a network interface card, a modem, and any combination thereof. Examples of a network 330 (or network segment 330) include a wide area network (WAN) (e.g., the Internet, an enterprise network), a local area network (LAN), a telephone network, virtual private network (VPN), cellular network, wireless network, or a direct connection between two computing devices, and any combinations thereof. The network 330 may employ any wired and/or a wireless mode of communication.

Information and data can be displayed through a display(s) 332. Examples of a display 332 include a liquid crystal display (LCD), an organic liquid crystal display (OLED), a cathode ray tube (CRT), a plasma display, and any combinations thereof. The display 332 can interface to the processor(s) 301, memory 303, fixed storage 308, as well as other devices (i.e., input device(s) 333) via the bus 340. The display 332 can be linked to the bus 340 via a video interface 322, and transport of data between the display 332 and the bus 340 can be controlled via graphics controller 321. The results presented by the machine learning module 60 may also be displayed by the display 332.

The computer system 300 may include one or more other peripheral output devices 634 including an audio speaker, a printer, and any combinations thereof. Such peripheral output devices may be connected to the bus 340 via an output interface 324. Examples of an output interface 324 include a serial port, a parallel connection, a USB port, a network port, a FIREWIRE port, a THUNDERBOLT port, and any combinations thereof.

Computer system 300 may also provide functionality as a result of logic hardwired or otherwise embodied in a circuit, which may operate in place of or together with software to execute the process(es) or step(s) described herein. Software in the computer system 300 may encompass logic, and reference to logic may encompass software. As well, the non-transitory, tangible computer-readable medium may encompass a circuit (such as an IC) storing software for execution, a circuit embodying logic for execution, or both.

Within computer system 300, the same reference characters are used to refer to terminals, signal lines, wires, etc. and their corresponding signals. The terms signal and wire can represent one or more signals, e.g., the conveyance of a single bit through a single wire or the conveyance of multiple parallel bits through multiple parallel wires. And each wire or signal may represent unidirectional or bidirectional communication between two or more components connected by a signal or wire.

The various logical blocks, modules, and circuits described herein may be implemented or performed with a general purpose processor, a digital signal processor (DSP), ASIC, GPU, a FPGA or other programmable logic device, discrete gate or transistor logic, discrete hardware components, or any combination thereof designed to perform the functions described herein. A general purpose processor may be a microprocessor or may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other similar configuration.

The compensation plans described herein exhibit several useful features. One of these features is that those not within the network of an MLM company can participate in the compensation system. Another useful feature is the compensation system contains an inherent incentive to convince customers to become an affiliate in the compensation system, and an affiliate to become a distributor. Another useful feature is the near time compensation of affiliates and/or distributors, provide an immediate reward system on the purchase of products.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, the examples and embodiments, in all respects, are meant to be illustrative only and should not be construed to be limiting in any manner.

1. A compensation method, comprising:
creating a network compensation system for sales of products, the system containing a distribution network with multiple levels of distributors;
allowing an affiliate to recommend a product to a customer;
allocating a position in the network to the affiliate; and
distributing compensation under the system to the affiliate or a distributor in near real time upon purchase of the product by the customer.

2. The method of claim 1, wherein the network compensation system comprises a unilevel system with 5 levels of distributors.

3. The method of claim 1, wherein the affiliate recommends a product using sponsored websites, banner ads, text ads, social media, links on its own websites, email to its own connections, or purchase or referral link with a discount code, or via social media.

4. The method of claim 3, wherein the discount code is generated automatically when the affiliate or the distributor accesses the network compensation system.

5. The method of claim 1, further comprising allowing the affiliate to choose to become a distributor in the network compensation system.

6. The method of claim 1, further comprising removing the affiliate from the network if the affiliate stops recommending products to a customer for a specific time period.

7. The method of claim 1, wherein both the affiliate and the distributor receive compensation upon purchase of a product by a consumer referred by the affiliate.

8. The method of claim 7, wherein the affiliate is compensated differently than the distributor.

9. The method of claim 7, wherein the compensation received by the affiliate is only a specific percentage of the product price.

10. The method of claim 7, where multiple distributors receive compensation upon purchase of the product.

11. The method of claim 1, wherein the affiliate can receive additional compensation if the customer purchasing the product recommends the product to another customer who also purchases the product.

12. The method of claim 1, further comprising distributing the compensation via ACH transfer, wire, credit to an existing account, electronic transfer to a debit card or credit card, or via a third party payment platform.

13. The method of claim 1, wherein distributing the compensation first comprises calculating the amount of the compensation.

14. The method of claim 13, wherein calculating the amount of the compensation is performed in seconds or minutes.

15. The method of claim 14, wherein the compensation is distributed to the affiliate or the distributor within second or minutes.

16. A compensation method, comprising:
creating a network compensation system for sales of products, the system containing a distribution network with multiple levels of distributors;
allowing an affiliate to recommend a product to a customer using sponsored websites, banner ads, text ads, social media, links on its own websites, email to its own connections, or purchase or referral link with a discount code, or via social media;
allocating a position in the network to the affiliate; and
distributing compensation under the system to the affiliate and a distributor in near real time upon purchase of the product by the customer referred by the affiliate.

17. The method of claim 16, further comprising allowing the affiliate to choose to become a distributor in the network compensation system.

18. The method of claim 16, wherein the affiliate is compensated differently than the distributor.

19. The method of claim 16, wherein the affiliate can receive additional compensation if the customer purchasing the product recommends the product to another customer who also purchases the product.

20. The method of claim 16, further comprising distributing the compensation via ACH transfer, wire, credit to an existing account, electronic transfer to a debit card or credit card, or via a third party payment platform within second or minutes.
